(19) United States
(12) Patent Application Publication
(10) Pub. No.: US 2026/0292834 A1
(43) Pub. Date: Sep. 24, 2026

(54) METHOD AND DEVICE FOR PERFORMING UPLINK TRANSMISSION AND RECEPTION IN WIRELESS COMMUNICATION SYSTEM

(71) Applicant: LG ELECTRONICS INC., Seoul (KR)

(72) Inventors: Hyungtae KIM, Seoul (KR); Jiwon KANG, Seoul (KR); Haewook PARK, Seoul (KR)

(73) Assignee: LG ELECTRONICS INC., Seoul (KR)

(21) Appl. No.: 19/479,684

(22) PCT Filed: May 8, 2024
(86) PCT No.: PCT/KR2024/006138

§ 371 Date: Oct. 28, 2025

Related U.S. Application Data
(60) Provisional application No. 63/464,933, filed on May 8, 2023.

(30) Foreign Application Priority Data
May 12, 2023 (KR) 10-2023-0061813

(51) Int. Cl. H04W 72/21; H04B 7/0404; H04W 24/10; H04W 52/14; H04W 72/231; H04W 72/232

(52) U.S. Cl. CPC H04W 72/21; H04B 7/0404; H04W 24/10; H04W 52/146; H04W 72/231; H04W 72/232

(57) ABSTRACT

Disclosed are a method and a device for performing uplink transmission and reception in a wireless communication system. The method by which a terminal performs uplink transmission, according to an embodiment of the present disclosure, comprises the steps of: transmitting, to a base station, first capability information related to a plurality of capability value indexes and second capability information related to coherency between the plurality of capability values; on the basis of the first capability information and the second capability information, receiving third information related to the uplink transmission from the base station; and performing the uplink transmission on the basis of the third information, wherein the first capability information may include at least one of i) the maximum number of sounding reference signal (SRS) ports supported by each of the plurality of capability value indexes and ii) a coherence type or a power mode supported by each of the plurality of capability value indexes.

### CROSS-REFERENCE TO RELATED APPLICATION(S)

This application is the National Stage filing under 35 U.S.C. 371 of International Application No. PCT/KR2024/006138, filed on May 8, 2024, which claims the benefit of earlier filing date and right of priority to Korean Application No. 10-2023-0061813, filed on May 12, 2023, and also claims the benefit of U.S. Provisional Application No. 63/464,933, filed on May 8, 2023, the contents of which are all incorporated by reference herein in their entirety.

### TECHNICAL FIELD

The present disclosure relates to a wireless communication system, and more specifically, to a method and device for performing uplink transmission and reception or downlink transmission and reception in a wireless communication system.

### BACKGROUND

A mobile communication system has been developed to provide a voice service while guaranteeing mobility of users. However, a mobile communication system has extended even to a data service as well as a voice service, and currently, an explosive traffic increase has caused shortage of resources and users have demanded a faster service, so a more advanced mobile communication system has been required.

The requirements of a next-generation mobile communication system at large should be able to support accommodation of explosive data traffic, a remarkable increase in a transmission rate per user, accommodation of the significantly increased number of connected devices, very low End-to-End latency and high energy efficiency. To this end, a variety of technologies such as Dual Connectivity, Massive Multiple Input Multiple Output (Massive MIMO), In-band Full Duplex, Non-Orthogonal Multiple Access (NOMA), Super wideband Support, Device Networking, etc. have been researched.

### SUMMARY

The technical problem of the present disclosure is to provide a method and device for performing uplink transmission and reception in a wireless communication system.

Furthermore, the technical problem of the present disclosure is to provide a method and device for reporting capability information for each of a plurality of panels with different attributes.

Furthermore, the technical problem of the present disclosure is to provide a method and device for performing uplink (simultaneous) transmission based on a plurality of panels based on capability information transmitted for each panel.

The technical objects to be achieved by the present disclosure are not limited to the above-described technical objects, and other technical objects which are not described herein will be clearly understood by those skilled in the pertinent art from the following description.

According to one embodiment of the present disclosure, a method for a UE to perform uplink transmission in a wireless communication system may include transmitting, to a base station, first capability information related to a plurality of capability value indices and second capability information related to coherency between the plurality of capability values; receiving, from the base station, third information related to the uplink transmission based on the first capability information and the second capability information; and performing the uplink transmission based on the third information, and the first capability information may include i) a maximum number of sounding reference signal (SRS) ports supported by each of the plurality of capability value indices and ii) at least one of a coherence type or a power mode supported by each of the plurality of capability value indices.

According to another embodiment of the present disclosure, a method for a base station to perform uplink reception in a wireless communication system may include receiving, from a user equipment (UE), first capability information related to a plurality of capability value indices and second capability information related to coherency between the plurality of capability values; transmitting, to the UE, third information related to the uplink transmission based on the first capability information and the second capability information; and performing the uplink reception based on the third information, and the first capability information may include i) a maximum number of sounding reference signal (SRS) ports supported by each of the plurality of capability value indices and ii) at least one of a coherence type or a power mode supported by each of the plurality of capability value indices.

According to various embodiments of the present disclosure, a method and device for performing uplink transmission and reception in a wireless communication may be provided.

Furthermore, according to various embodiments of the present disclosure, a method and device for reporting capability information for each of a plurality of panels with different attributes may be provided.

Furthermore, according to various embodiments of the present disclosure, a method and device for performing uplink (simultaneous) transmission based on a plurality of panels may be provided based on capability information transmitted for each panel.

Furthermore, according to various embodiments of the present disclosure, a terminal may efficiently perform STxMP (Simultaneous Transmission Multi-Panel)-based transmission.

The technical objects to be achieved by the present disclosure are not limited to the above-described technical objects, and other technical objects which are not described herein will be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a structure of a wireless communication system to which the present disclosure may be applied.

FIG. 2 illustrates a frame structure in a wireless communication system to which the present disclosure may be applied.

FIG. 3 illustrates a resource grid in a wireless communication system to which the present disclosure may be applied.

FIG. 4 illustrates a physical resource block in a wireless communication system to which the present disclosure may be applied.

FIG. 5 illustrates a slot structure in a wireless communication system to which the present disclosure may be applied.

FIG. 6 illustrates physical channels used in a wireless communication system to which the present disclosure may be applied and a general signal transmission and reception method using them.

FIG. 7 illustrates a signaling procedure between a network and a UE for an uplink transmission and reception method according to an embodiment of the present disclosure.

FIG. 8 is a diagram illustrating an uplink transmission operation of a UE in a wireless communication system to which the present disclosure can be applied.

FIG. 9 is a diagram illustrating an uplink reception operation of a base station in a wireless communication system to which the present disclosure can be applied.

FIG. 10 is a block diagram illustrating a wireless communication device according to an embodiment of the present disclosure.

### DETAILED DESCRIPTION

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art knows that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

The present disclosure describes a wireless communication network or a wireless communication system, and an operation performed in a wireless communication network may be performed in a process in which a device (e.g., a base station) controlling a corresponding wireless communication network controls a network and transmits or receives a signal, or may be performed in a process in which a terminal associated to a corresponding wireless network transmits or receives a signal with a network or between terminals.

In the present disclosure, transmitting or receiving a channel includes a meaning of transmitting or receiving information or a signal through a corresponding channel. For example, transmitting a control channel means that control information or a control signal is transmitted through a control channel. Similarly, transmitting a data channel means that data information or a data signal is transmitted through a data channel.

Hereinafter, a downlink (DL) means a communication from a base station to a terminal and an uplink (UL) means a communication from a terminal to a base station. In a downlink, a transmitter may be part of a base station and a receiver may be part of a terminal. In an uplink, a transmitter may be part of a terminal and a receiver may be part of a base station. A base station may be expressed as a first communication device and a terminal may be expressed as a second communication device. A base station (BS) may be substituted with a term such as a fixed station, a Node B, an eNB (evolved-NodeB), a gNB (Next Generation NodeB), a BTS (base transceiver system), an Access Point (AP), a Network (5G network), an AI (Artificial Intelligence) system/module, an RSU (road side unit), a robot, a drone (UAV: Unmanned Aerial Vehicle), an AR (Augmented Reality) device, a VR (Virtual Reality) device, etc. In addition, a terminal may be fixed or mobile, and may be substituted with a term such as a UE (User Equipment), an MS (Mobile Station), a UT (user terminal), an MSS (Mobile Subscriber Station), an SS (Subscriber Station), an AMS (Advanced Mobile Station), a WT (Wireless terminal), an MTC (Machine-Type Communication) device, an M2M (Machine-to-Machine) device, a D2D (Device-to-Device) device, a vehicle, an RSU (road side unit), a robot, an AI (Artificial Intelligence) module, a drone (UAV: Unmanned Aerial Vehicle), an AR (Augmented Reality) device, a VR (Virtual Reality) device, etc.

The following description may be used for a variety of radio access systems such as CDMA, FDMA, TDMA, OFDMA, SC-FDMA, etc. CDMA may be implemented by a wireless technology such as UTRA (Universal Terrestrial Radio Access) or CDMA2000. TDMA may be implemented by a radio technology such as GSM (Global System for Mobile communications)/GPRS (General Packet Radio Service)/EDGE (Enhanced Data Rates for GSM Evolution). OFDMA may be implemented by a radio technology such as IEEE 802.11 (Wi-Fi), IEEE 802.16 (WiMAX), IEEE 802-20, E-UTRA (Evolved UTRA), etc. UTRA is a part of a UMTS (Universal Mobile Telecommunications System). 3GPP (3rd Generation Partnership Project) LTE (Long Term Evolution) is a part of an E-UMTS (Evolved UMTS) using E-UTRA and LTE-A (Advanced)/LTE-A pro is an advanced version of 3GPP LTE. 3GPP NR (New Radio or New Radio Access Technology) is an advanced version of 3GPP LTE/LTE-A/LTE-A pro.

To clarify description, it is described based on a 3GPP communication system (e.g., LTE-A, NR), but a technical idea of the present disclosure is not limited thereto. LTE means a technology after 3GPP TS (Technical Specification) 36.xxx Release 8. In detail, an LTE technology in or after 3GPP TS 36.xxx Release 10 is referred to as LTE-A and an LTE technology in or after 3GPP TS 36.xxx Release 13 is referred to as LTE-A pro. 3GPP NR means a technology in or after TS 38.xxx Release 15. LTE/NR may be referred to as a 3GPP system. “xxx” means a detailed number for a standard document. LTE/NR may be commonly referred to as a 3GPP system. For a background art, a term, an abbreviation, etc. used to describe the present disclosure, matters described in a standard document disclosed before the present disclosure may be referred to. For example, the following document may be referred to.

For 3GPP LTE, TS 36.211 (physical channels and modulation), TS 36.212 (multiplexing and channel coding), TS 36.213 (physical layer procedures), TS 36.300 (overall description), TS 36.331 (radio resource control) may be referred to.

For 3GPP NR, TS 38.211 (physical channels and modulation), TS 38.212 (multiplexing and channel coding), TS 38.213 (physical layer procedures for control), TS 38.214 (physical layer procedures for data), TS 38.300 (NR and NG-RAN (New Generation-Radio Access Network) overall description), TS 38.331 (radio resource control protocol specification) may be referred to.

Abbreviations of terms which may be used in the present disclosure is defined as follows.
BM: beam management
CQI: Channel Quality Indicator
CRI: channel state information-reference signal resource indicator
CSI: channel state information
CSI-IM: channel state information-interference measurement
CSI-RS: channel state information-reference signal
DMRS: demodulation reference signal
FDM: frequency division multiplexing
FFT: fast Fourier transform
IFDMA: interleaved frequency division multiple access
IFFT: inverse fast Fourier transform
L1-RSRP: Layer 1 reference signal received power
L1-RSRQ: Layer 1 reference signal received quality
MAC: medium access control
NZP: non-zero power
OFDM: orthogonal frequency division multiplexing
PDCCH: physical downlink control channel
PDSCH: physical downlink shared channel
PMI: precoding matrix indicator
RE: resource element
RI: Rank indicator
RRC: radio resource control
RSSI: received signal strength indicator
Rx: Reception
QCL: quasi co-location
SINR: signal to interference and noise ratio
SSB (or SS/PBCH block): Synchronization signal block (including PSS (primary synchronization signal), SSS (secondary synchronization signal) and PBCH (physical broadcast channel))
TDM: time division multiplexing
TRP: transmission and reception point
TRS: tracking reference signal
Tx: transmission
UE: user equipment
ZP: zero power

### Overall System

As more communication devices have required a higher capacity, a need for an improved mobile broadband communication compared to the existing radio access technology (RAT) has emerged. In addition, massive MTC (Machine Type Communications) providing a variety of services anytime and anywhere by connecting a plurality of devices and things is also one of main issues which will be considered in a next-generation communication. Furthermore, a communication system design considering a service/a terminal sensitive to reliability and latency is also discussed. As such, introduction of a next-generation RAT considering eMBB (enhanced mobile broadband communication), mMTC (massive MTC), URLLC (Ultra-Reliable and Low Latency Communication), etc. is discussed and, for convenience, a corresponding technology is referred to as NR in the present disclosure. NR is an expression which represents an example of a 5G RAT.

A new RAT system including NR uses an OFDM transmission method or a transmission method similar to it. A new RAT system may follow OFDM parameters different from OFDM parameters of LTE. Alternatively, a new RAT system follows a numerology of the existing LTE/LTE-A as it is, but may support a wider system bandwidth (e.g., 100 MHz). Alternatively, one cell may support a plurality of numerologies. In other words, terminals which operate in accordance with different numerologies may coexist in one cell.

A numerology corresponds to one subcarrier spacing in a frequency domain. As a reference subcarrier spacing is scaled by an integer N, a different numerology may be defined.

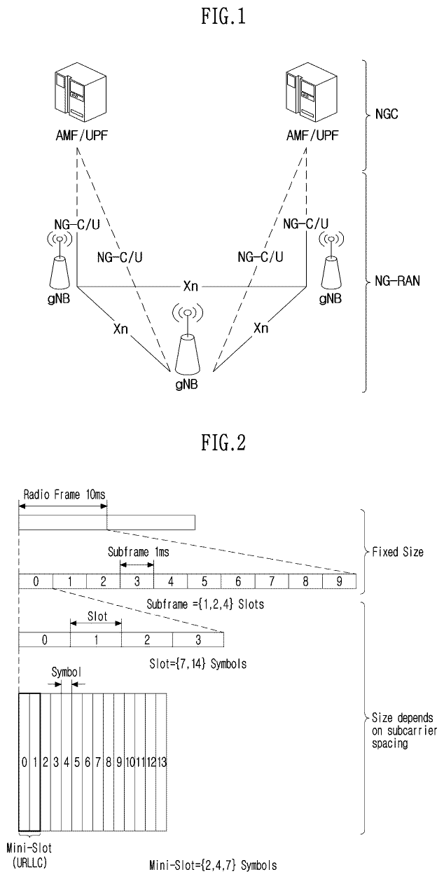

FIG. 1 illustrates a structure of a wireless communication system to which the present disclosure may be applied.

In reference to FIG. 1, NG-RAN is configured with gNBs which provide a control plane (RRC) protocol end for a NG-RA (NG-Radio Access) user plane (i.e., a new AS (access stratum) sublayer/PDCP (Packet Data Convergence Protocol)/RLC (Radio Link Control)/MAC/PHY) and UE. The gNBs are interconnected through a Xn interface. The gNB, in addition, is connected to an NGC (New Generation Core) through an NG interface. In more detail, the gNB is connected to an AMF (Access and Mobility Management Function) through an N2 interface, and is connected to a UPF (User Plane Function) through an N3 interface.

FIG. 2 illustrates a frame structure in a wireless communication system to which the present disclosure may be applied.

A NR system may support a plurality of numerologies. Here, a numerology may be defined by a subcarrier spacing and a cyclic prefix (CP) overhead. Here, a plurality of subcarrier spacings may be derived by scaling a basic (reference) subcarrier spacing by an integer N (or, u). In addition, although it is assumed that a very low subcarrier spacing is not used in a very high carrier frequency, a used numerology may be selected independently from a frequency band. In addition, a variety of frame structures according to a plurality of numerologies may be supported in a NR system.

Hereinafter, an OFDM numerology and frame structure which may be considered in a NR system will be described. A plurality of OFDM numerologies supported in a NR system may be defined as in the following Table 1.

TABLE 1

| μ | Δf = 2^{μ} · 15 [kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

NR supports a plurality of numerologies (or subcarrier spacings (SCS)) for supporting a variety of 5G services. For example, when a SCS is 15 kHz, a wide area in traditional cellular bands is supported, and when a SCS is 30 kHz/60 kHz, dense-urban, lower latency and a wider carrier bandwidth are supported, and when a SCS is 60 kHz or higher, a bandwidth wider than 24.25 GHz is supported to overcome a phase noise. An NR frequency band is defined as a frequency range in two types (FR1, FR2). FR1, FR2 may be configured as in the following Table 2. In addition, FR2 may mean a millimeter wave (mmW).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

Regarding a frame structure in an NR system, a size of a variety of fields in a time domain is expresses as a multiple of a time unit of T_{c}=1/(Δfₘₐₓ·N_{f}). Here, Δfₘₐₓ·is 480·10³ Hz and N_{f} is 4096. Downlink and uplink transmission is configured (organized) with a radio frame having a duration of T_{f}=1/(Δfₘₐₓ·N_{f}/100)·T_{c}=10 ms. Here, a radio frame is configured with 10 subframes having a duration of T_{sf}=(Δfₘₐₓ·N_{f}/1000). T_{c}=1 ms, respectively. In this case, there may be one set of frames for an uplink and one set of frames for a downlink. In addition, transmission in an uplink frame No. i from a terminal should start earlier by T_{TA}=(N_{TA}+N_{TA,offset})T_{c} than a corresponding downlink frame in a corresponding terminal starts. For a subcarrier spacing configuration u, slots are numbered in an increasing order of nₛ^{μ}ϵ{0, . . . , Nₛₗₒₜ^{subframe,μ}−1} in a subframe and are numbered in an increasing order of n_{s,f}^{μ}ϵ{0, . . . , Nₛₗₒₜ^{frame,μ}−1} in a radio frame. One slot is configured with N_{symb}^{slot} consecutive OFDM symbols and N_{symb}^{slot} is determined according to CP. A start of a slot nₛ^{μ} in a subframe is temporally arranged with a start of an OFDM symbol nₛ^{μ}N_{symb}^{slot} in the same subframe. All terminals may not perform transmission and reception at the same time, which means that all OFDM symbols of a downlink slot or an uplink slot may not be used. Table 3 represents the number of OFDM symbols per slot (N_{symb}^{slot}), the number of slots per radio frame (Nₛₗₒₜ^{frame,μ}) and the number of slots per subframe (Nₛₗₒₜ^{subframe,μ}) in a normal CP and Table 4 represents the number of OFDM symbols per slot, the number of slots per radio frame and the number of slots per subframe in an extended CP.

TABLE 3

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame, μ} | Nₛₗₒₜ^{subframe, μ} |
|---|---|---|---|
| 2 | 12 | 40 | 4 |

FIG. 2 is an example on μ=2 (SCS is 60 kHz), 1 subframe may include 4 slots referring to Table 3. 1 subframe={1,2,4} slot shown in FIG. 2 is an example, the number of slots which may be included in 1 subframe is defined as in Table 3 or Table 4. In addition, a mini-slot may include 2, 4 or 7 symbols or more or less symbols. Regarding a physical resource in a NR system, an antenna port, a resource grid, a resource element, a resource block, a carrier part, etc. may be considered. Hereinafter, the physical resources which may be considered in an NR system will be described in detail. First, in relation to an antenna port, an antenna port is defined so that a channel where a symbol in an antenna port is carried can be inferred from a channel where other symbol in the same antenna port is carried. When a large-scale property of a channel where a symbol in one antenna port is carried may be inferred from a channel where a symbol in other antenna port is carried, it may be said that 2 antenna ports are in a QC/QCL (quasi co-located or quasi co-location) relationship. In this case, the large-scale property includes at least one of delay spread, doppler spread, frequency shift, average received power, received timing.

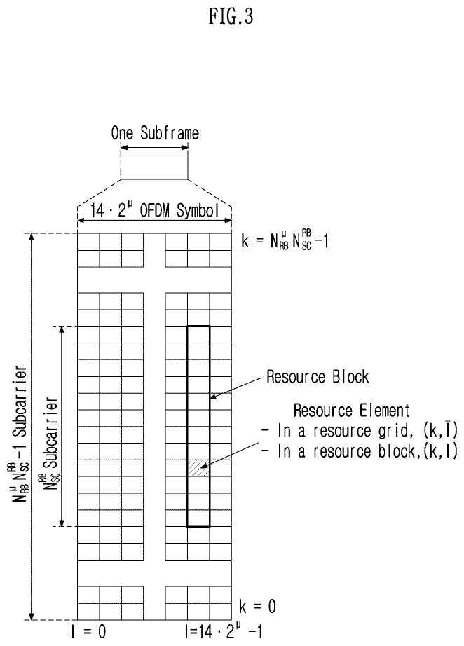

FIG. 3 illustrates a resource grid in a wireless communication system to which the present disclosure may be applied.

In reference to FIG. 3, it is illustratively described that a resource grid is configured with N_{RB}^{μ}N_{sc}^{RB} subcarriers in a frequency domain and one subframe is configured with 14.24 OFDM symbols, but it is not limited thereto. In an NR system, a transmitted signal is described by OFDM symbols of 2^{μ}N_{symb}^{(μ)} and one or more resource grids configured with N_{RB}^{μ}N_{sc}^{RB} subcarriers. Here, N_{RB}^{μ}≤N_{RB}^{max,μ}. The N_{RB}^{max,μ} represents a maximum transmission bandwidth, which may be different between an uplink and a downlink as well as between numerologies. In this case, one resource grid may be configured per u and antenna port p. Each element of a resource grid for μ and an antenna port p is referred to as a resource element and is uniquely identified by an index pair (k,l′).

Here, k=0, . . . , N_{RB}^{μ}N_{sc}^{RB}−1 is an index in a frequency domain and l′=0, . . . , 2^{μ}N_{symb}^{(μ)}−1 refers to a position of a symbol in a subframe. When referring to a resource element in a slot, an index pair (k,l) is used. Here, l=0, . . . , N_{symb}^{μ}−1. A resource element (k,l′) for μ and an antenna port p corresponds to a complex value, a_{k,l′}^{(p,μ)}. When there is no risk of confusion or when a specific antenna port or numerology is not specified, indexes p and u may be dropped, whereupon a complex value may be a_{k,l′}^{(p)} or a_{k,l′}. In addition, a resource block (RB) is defined as N_{sc}^{RB}=12 consecutive subcarriers in a frequency domain.

Point A plays a role as a common reference point of a resource block grid and is obtained as follows.

offsetToPointA for a primary cell (PCell) downlink represents a frequency offset between point A and the lowest subcarrier of the lowest resource block overlapped with a SS/PBCH block which is used by a terminal for an initial cell selection. It is expressed in resource block units assuming a 15 kHz subcarrier spacing for FR1 and a 60 kHz subcarrier spacing for FR2.

absoluteFrequencyPointA represents a frequency-position of point A expressed as in ARFCN (absolute radio-frequency channel number).

Common resource blocks are numbered from 0 to the top in a frequency domain for a subcarrier spacing configuration μ. The center of subcarrier 0 of common resource block 0 for a subcarrier spacing configuration μ is identical to ‘point A’. A relationship between a common resource block number n_{CRB}^{μ} and a resource element (k,l) for a subcarrier spacing configuration μ in a frequency domain is given as in the following Equation 1.

$${n}_{CRB}^{μ} = ⌊ \frac{k}{{N}_{sc}^{RB}} ⌋ \qquad [ Equation 1 ]$$

In Equation 1, k is defined relatively to point A so that k=0 corresponds to a subcarrier centering in point A. Physical resource blocks are numbered from 0 to N_{BWP,i}^{size,μ}−1 in a bandwidth part (BWP) and i is a number of a BWP. A relationship between a physical resource block nPRB and a common resource block n_{CRB} in BWP i is given by the following Equation 2.

$${n}_{CRB}^{μ} = {n}_{PRB}^{μ} + {N}_{BWP , i}^{start , μ} \qquad [ Equation 2 ]$$

N_{BWP,i}^{start,μ} is a common resource block that a BWP starts relatively to common resource block 0.

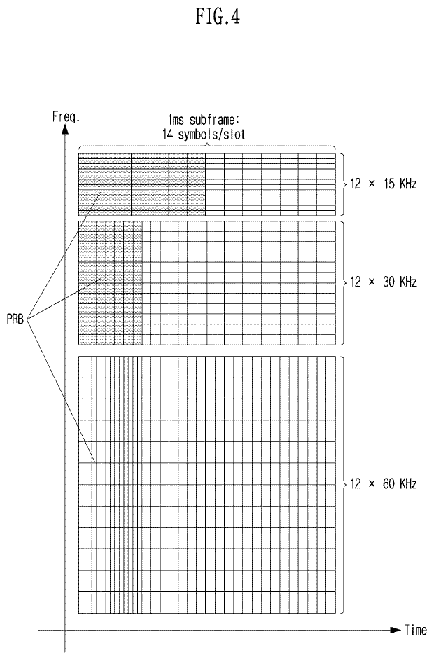

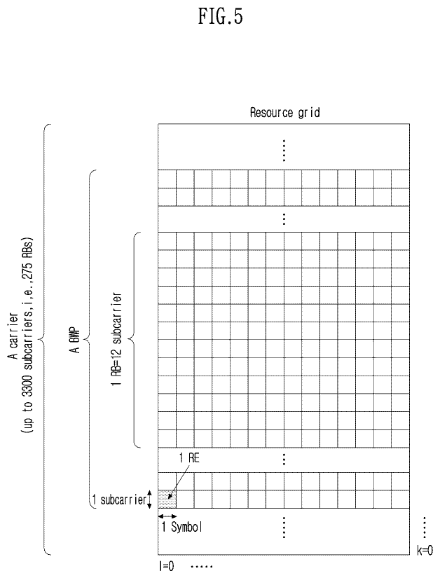

FIG. 4 illustrates a physical resource block in a wireless communication system to which the present disclosure may be applied. And, FIG. 5 illustrates a slot structure in a wireless communication system to which the present disclosure may be applied.

In reference to FIG. 4 and FIG. 5, a slot includes a plurality of symbols in a time domain. For example, for a normal CP, one slot includes 7 symbols, but for an extended CP, one slot includes 6 symbols.

A carrier includes a plurality of subcarriers in a frequency domain. An RB (Resource Block) is defined as a plurality of (e.g., 12) consecutive subcarriers in a frequency domain. A BWP (Bandwidth Part) is defined as a plurality of consecutive (physical) resource blocks in a frequency domain and may correspond to one numerology (e.g., an SCS, a CP length, etc.). A carrier may include a maximum N (e.g., 5) BWPs. A data communication may be performed through an activated BWP and only one BWP may be activated for one terminal. In a resource grid, each element is referred to as a resource element (RE) and one complex symbol may be mapped.

In an NR system, up to 400 MHz may be supported per component carrier (CC). If a terminal operating in such a wideband CC always operates turning on a radio frequency (FR) chip for the whole CC, terminal battery consumption may increase. Alternatively, when several application cases operating in one wideband CC (e.g., eMBB, URLLC, Mmtc, V2X, etc.) are considered, a different numerology (e.g., a subcarrier spacing, etc.) may be supported per frequency band in a corresponding CC. Alternatively, each terminal may have a different capability for the maximum bandwidth. By considering it, a base station may indicate a terminal to operate only in a partial bandwidth, not in a full bandwidth of a wideband CC, and a corresponding partial bandwidth is defined as a bandwidth part (BWP) for convenience. A BWP may be configured with consecutive RBs on a frequency axis and may correspond to one numerology (e.g., a subcarrier spacing, a CP length, a slot/a mini-slot duration).

Meanwhile, a base station may configure a plurality of BWPs even in one CC configured to a terminal. For example, a BWP occupying a relatively small frequency domain may be configured in a PDCCH monitoring slot, and a PDSCH indicated by a PDCCH may be scheduled in a greater BWP.

Alternatively, when UEs are congested in a specific BWP, some terminals may be configured with other BWP for load balancing. Alternatively, considering frequency domain inter-cell interference cancellation between neighboring cells, etc., some middle spectrums of a full bandwidth may be excluded and BWPs on both edges may be configured in the same slot. In other words, a base station may configure at least one DL/UL BWP to a terminal associated with a wideband CC. A base station may activate at least one DL/UL BWP of configured DL/UL BWP(s) at a specific time (by L1 signaling or MAC CE (Control Element) or RRC signaling, etc.).

In addition, a base station may indicate switching to other configured DL/UL BWP (by L1 signaling or MAC CE or RRC signaling, etc.). Alternatively, based on a timer, when a timer value is expired, it may be switched to a determined DL/UL BWP. Here, an activated DL/UL BWP is defined as an active DL/UL BWP. But, a configuration on a DL/UL BWP may not be received when a terminal performs an initial access procedure or before a RRC connection is set up, so a DL/UL BWP which is assumed by a terminal under these situations is defined as an initial active DL/UL BWP.

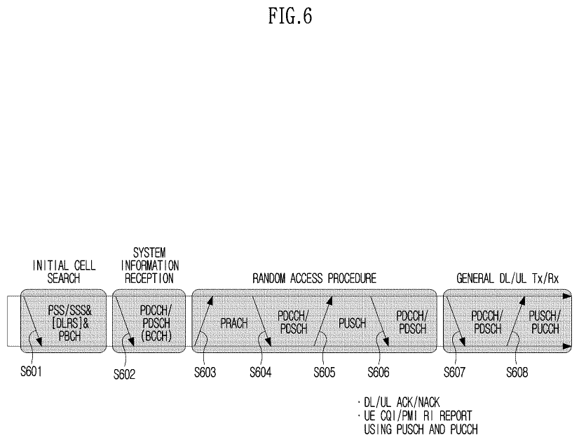

FIG. 6 illustrates physical channels used in a wireless communication system to which the present disclosure may be applied and a general signal transmission and reception method using them.

In a wireless communication system, a terminal receives information through a downlink from a base station and transmits information through an uplink to a base station. Information transmitted and received by a base station and a terminal includes data and a variety of control information and a variety of physical channels exist according to a type/a usage of information transmitted and received by them.

When a terminal is turned on or newly enters a cell, it performs an initial cell search including synchronization with a base station or the like (S601). For the initial cell search, a terminal may synchronize with a base station by receiving a primary synchronization signal (PSS) and a secondary synchronization signal (SSS) from a base station and obtain information such as a cell identifier (ID), etc. After that, a terminal may obtain broadcasting information in a cell by receiving a physical broadcast channel (PBCH) from a base station. Meanwhile, a terminal may check out a downlink channel state by receiving a downlink reference signal (DL RS) at an initial cell search stage.

A terminal which completed an initial cell search may obtain more detailed system information by receiving a physical downlink control channel (PDCCH) and a physical downlink shared channel (PDSCH) according to information carried in the PDCCH (S602).

Meanwhile, when a terminal accesses to a base station for the first time or does not have a radio resource for signal transmission, it may perform a random access (RACH) procedure to a base station (S603 to S606). For the random access procedure, a terminal may transmit a specific sequence as a preamble through a physical random access channel (PRACH) (S603 and S605) and may receive a response message for a preamble through a PDCCH and a corresponding PDSCH (S604 and S606). A contention based RACH may additionally perform a contention resolution procedure.

A terminal which performed the above-described procedure subsequently may perform PDCCH/PDSCH reception (S607) and PUSCH (Physical Uplink Shared Channel)/PUCCH (physical uplink control channel) transmission (S608) as a general uplink/downlink signal transmission procedure. In particular, a terminal receives downlink control information (DCI) through a PDCCH. Here, DCI includes control information such as resource allocation information for a terminal and a format varies depending on its purpose of use.

Meanwhile, control information which is transmitted by a terminal to a base station through an uplink or is received by a terminal from a base station includes a downlink/uplink ACK/NACK (Acknowledgement/Non-Acknowledgement) signal, a CQI (Channel Quality Indicator), a PMI (Precoding Matrix Indicator), a RI (Rank Indicator), etc. For a 3GPP LTE system, a terminal may transmit control information of the above-described CQI/PMI/RI, etc. through a PUSCH and/or a PUCCH.

Table 5 represents an example of a DCI format in an NR system.

TABLE 5

| DCI | |
|---|---|
| Format | Use |
| 0_0 | Scheduling of a PUSCH in one cell |
| 0_1 | Scheduling of one or multiple PUSCHs in one |
| | cell, or indication of cell group downlink |
| | feedback information to a UE |
| 0_2 | Scheduling of a PUSCH in one cell |
| 1_0 | Scheduling of a PDSCH in one DL cell |
| 1_1 | Scheduling of a PDSCH in one cell |
| 1_2 | Scheduling of a PDSCH in one cell |

In reference to Table 5, DCI formats 0_0, 0_1 and 0_2 may include resource information (e.g., UL/SUL (Supplementary UL), frequency resource allocation, time resource allocation, frequency hopping, etc.), information related to a transport block (TB) (e.g., MCS (Modulation Coding and Scheme), a NDI (New Data Indicator), a RV (Redundancy Version), etc.), information related to a HARQ (Hybrid-Automatic Repeat and request) (e.g., a process number, a DAI (Downlink Assignment Index), PDSCH-HARQ feedback timing, etc.), information related to multiple antennas (e.g., DMRS sequence initialization information, an antenna port, a CSI request, etc.), power control information (e.g., PUSCH power control, etc.) related to scheduling of a PUSCH and control information included in each DCI format may be pre-defined. DCI format 0_0 is used for scheduling of a PUSCH in one cell. Information included in DCI format 0_0 is CRC (cyclic redundancy check) scrambled by a C-RNTI (Cell Radio Network Temporary Identifier) or a CS-RNTI (Configured Scheduling RNTI) or a MCS-C-RNTI (Modulation Coding Scheme Cell RNTI) and transmitted. DCI format 0_1 is used to indicate scheduling of one or more PUSCHs or configure grant (CG) downlink feedback information to a terminal in one cell. Information included in DCI format 0_1 is CRC scrambled by a C-RNTI or a CS-RNTI or a SP-CSI-RNTI (Semi-Persistent CSI RNTI) or a MCS-C-RNTI and transmitted.

DCI format 0_2 is used for scheduling of a PUSCH in one cell. Information included in DCI format 0_2 is CRC scrambled by a C-RNTI or a CS-RNTI or a SP-CSI-RNTI or a MCS-C-RNTI and transmitted.

Next, DCI formats 1_0, 1_1 and 1_2 may include resource information (e.g., frequency resource allocation, time resource allocation, VRB (virtual resource block)-PRB (physical resource block) mapping, etc.), information related to a transport block (TB) (e.g., MCS, NDI, RV, etc.), information related to a HARQ (e.g., a process number, DAI, PDSCH-HARQ feedback timing, etc.), information related to multiple antennas (e.g., an antenna port, a TCI (transmission configuration indicator), a SRS (sounding reference signal) request, etc.), information related to a PUCCH (e.g., PUCCH power control, a PUCCH resource indicator, etc.) related to scheduling of a PDSCH and control information included in each DCI format may be pre-defined.

DCI format 1_0 is used for scheduling of a PDSCH in one DL cell. Information included in DCI format 1_0 is CRC scrambled by a C-RNTI or a CS-RNTI or a MCS-C-RNTI and transmitted.

DCI format 1_1 is used for scheduling of a PDSCH in one cell. Information included in DCI format 1_1 is CRC scrambled by a C-RNTI or a CS-RNTI or a MCS-C-RNTI and transmitted.

DCI format 1_2 is used for scheduling of a PDSCH in one cell. Information included in DCI format 1_2 is CRC scrambled by a C-RNTI or a CS-RNTI or a MCS-C-RNTI and transmitted.

### Quasi-Co Location (QCL)

Antenna ports are defined such that the channel through which a symbol on an antenna port is carried can be inferred from the channel through which another symbol on the same antenna port is carried. Two antenna ports are said to be in a QC/QCL (quasi co-located or quasi co-location) relationship if the properties of the channel through which a symbol on one antenna port is carried can be inferred from the channel through which a symbol on another antenna port is carried.

Here, the channel characteristics include at least one of delay spread, Doppler spread, frequency/Doppler shift, average received power, received timing/average delay, and spatial Rx parameter. Here, the spatial Rx parameter refers to a spatial (reception) channel characteristic parameter such as angle of arrival.

The UE may be configured with a list of up to M TCI-State configurations in the higher layer parameter PDSCH-Config to decode the PDSCH according to the detected PDCCH having the intended DCI for the UE and the given serving cell. The M depends on the UE capability.

Each TCI-State includes parameters for establishing a quasi co-location relationship between one or two DL reference signals and the DM-RS port of the PDSCH.

The quasi co-location relationship is configured by the higher layer parameters qcl-Type1 for the first DL RS and qcl-Type2 (if set) for the second DL RS. For two DL RSs, the QCL types are not the same, regardless of whether the references are the same DL RS or different DL RSs.

The quasi co-location type corresponding to each DL RS is given by the higher layer parameter qcl-Type of QCL-Info, and can take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

For example, if a target antenna port is a specific NZP CSI-RS, the corresponding NZP CSI-RS antenna port(s) can be indicated/configured to be QCL with a specific TRS from a QCL-Type A perspective and with a specific SSB from a QCL-Type D perspective. A UE that has received such an indication/configuration may receive the corresponding NZP CSI-RS using the Doppler and delay values measured at the QCL-TypeA TRS, and apply the reception beam used for QCL-TypeD SSB reception to the corresponding NZP CSI-RS reception.

The UE may receive an activation command by MAC CE signaling used to map up to eight TCI states to codepoints of the DCI field ‘Transmission Configuration Indication’.

### Multi-TRP Related Operations

Coordinated Multi Point (COMP) is a technique that effectively controls interference by having multiple base stations exchange (e.g., using the X2 interface) or utilize channel information (e.g., RI/CQI/PMI/LI (layer indicator)) fed back from terminals and cooperatively transmit it to terminals. Depending on the method used, CoMP can be categorized into joint transmission (JT), coordinated scheduling (CS), coordinated beamforming (CB), dynamic point selection (DPS), and dynamic point blocking (DPB).

The M-TRP transmission method, in which M TRPs transmit data to one UE, may be broadly divided into i) eMBB M-TRP transmission, a method for increasing transmission rate, and ii) URLLC M-TRP transmission, a method for increasing reception success rate and reducing latency.

In addition, from the perspective of DCI transmission, the M-TRP transmission method may be divided into i) M-TRP transmission based on M-DCI (multiple DCI) in which each TRP transmits a different DCI, and ii) M-TRP transmission based on S-DCI (single DCI) in which one TRP transmits a DCI. For example, in the case of S-DCI based M-TRP transmission, since all scheduling information for data transmitted by an M TRP must be transmitted to the terminal through a single DCI, it can be used in an ideal backhaul (ideal BH: ideal BackHaul) environment in which dynamic cooperation between the two TRPs is possible.

The UE may recognize the PUSCH (or PUCCH) scheduled by the DCI received in different control resource sets (CORESETs) (or CORESETs belonging to different CORESET groups) as a PUSCH (or PUCCH) transmitted in different TRPs or as a PDSCH (or PDCCH) of different TRPs. In addition, the method for UL transmission (e.g., PUSCH/PUCCH) transmitted in different TRPs described below may be equally applied to UL transmission (e.g., PUSCH/PUCCH) transmitted in different panels belonging to the same TRP.

Hereinafter, the CORESET group identifier (group ID) described/mentioned in the present disclosure may mean an index/identification information (e.g., ID) for distinguishing a CORESET for each TRP/panel. And the CORESET group may be a group/union of CORESETs distinguished by an index/identification information (e.g., ID)/the CORESET group ID for distinguishing a CORESET for each TRP/panel. For example, the CORESET group ID may be specific index information defined in the CORSET configuration. In this case, the CORESET group may be configured/indicated/defined by an index defined in the CORESET configuration for each CORESET. And/or the CORESET group ID may mean an index/identification information/indicator for distinguishing/identifying between CORESETs configured/associated with each TRP/panel. Hereinafter, the CORESET group ID described/mentioned in the present disclosure may be expressed by being replaced with a specific index/specific identification information/specific indicator for distinguishing/identifying the CORESETs configured/associated in each TRP/panel. The CORESET group ID, i.e., the specific index/specific identification information/specific indicator for distinguishing/identifying the CORESETs configured/associated in each TRP/panel, may be configured/indicated to the UE through higher layer signaling (e.g., RRC signaling)/second layer signaling (L2 signaling, e.g., MAC-CE)/first layer signaling (L1 signaling, e.g., DCI). For example, PDCCH detection may be configured/indicated to be performed for each TRP/panel (i.e., for each TRP/panel belonging to the same CORESET group) in units of the corresponding CORESET group. And/or, uplink control information (e.g., CSI, HARQ-A/N (ACK/NACK), SR (scheduling request)) and/or uplink physical channel resources (e.g., PUCCH/PRACH/SRS resources) may be separately managed/controlled for each TRP/panel in the corresponding CORESET group (i.e., for each TRP/panel belonging to the same CORESET group). And/or, HARQ A/N (process/retransmission) for PDSCH/PUSCH, etc. scheduled for each TRP/panel in the corresponding CORESET group (i.e., for each TRP/panel belonging to the same CORESET group) may be managed.

For example, the ControlResourceSet information element (IE), which is an higher layer parameter, is used to configure a time/frequency control resource set (CORESET). For example, the control resource set (CORESET) may be related to detection and reception of downlink control information. The ControlResourceSet IE may include a CORESET-related ID (e.g., controlResourceSetID)/an index of a CORESET pool for the CORESET (e.g., CORESETPoolIndex)/time/frequency resource configuration of the CORESET/TCI information related to the CORESET, etc. For example, the index of the CORESET pool (e.g., CORESETPoolIndex) may be set to 0 or 1. In the above description, a CORESET group may correspond to a CORESET pool, and a CORESET group ID may correspond to a CORESET pool index (e.g., CORESETPoolIndex).

The Rel-17 NR standard supports (1) MTRP PDCCH repeated transmission, (2) MTRP PDCCH single frequency network (SFN) transmission, (3) MTRP PDSCH SFN transmission, (4) S-DCI-based MTRP PUSCH repeated transmission, and (4) single PUCCH resource-based MTRP PUCCH repeated transmission. All of these transmission techniques are URLLC target enhancements for increasing reliability, in which the same contents (i.e., DCI or UL/DL TB or UCI) are repeatedly transmitted. In the case of MTRP PDCCH repetitive transmission, it is repeatedly transmitted in TDM or FDM, MTRP PDCCH/PDSCH SFN is repeatedly transmitted at the same time/frequency/layer, S-DCI-based MTRP PUSCH repetitive transmission is repeatedly transmitted in TDM, and single PUCCH resource-based MTRP PUCCH repetitive transmission is repeatedly transmitted in TDM.

### Simultaneous Transmission Across Multi-Panel (STxMP)

In Rel-18, the introduction of a method for a UE to simultaneously transmit multiple channels/reference signals (RSs) of the same type or multiple channels/RSs of different types is being discussed. In the case of a legacy UE, the operation of transmitting multiple channels/RSs at one time (i.e., the same time resource) is restricted (for example, it is possible to simultaneously transmit multiple SRS resources of different SRS resource sets for UL beam measurement, but it is not possible to simultaneously transmit multiple PUSCHs), but this restriction may be relaxed in the case of advanced UEs in the future, and the advanced UEs in the future will be able to simultaneously transmit multiple channels or RSs using multiple transmit panels. This operation may be referred to as simultaneous transmission across multi-panels (STxMP), and a UE supporting this operation may be referred to as an STxMP UE. For example, two PUSCHs (PUSCH 1, 2) corresponding to (carrying) two UL TBs may be scheduled in the same resource element (RE) (or multiple identical REs), and spatial relation RS 1 and power control (PC) parameter set 1 (i.e., UL TCI state 1) and spatial relation RS 2 and PC parameter set 2 (i.e., UL TCI state 2) may be configured for transmission of PUSCH 1 and 2, respectively. The UE may transmit PUSCH 1 using panel 1 corresponding to UL TCI state 1, and simultaneously transmit PUSCH 2 using panel 2 corresponding to UL TCI state 2.

When scheduling a PUSCH through DCI, the base station may indicate whether the PUSCH will be transmitted in STxMP, in a single panel, or in M-TRP PUSCH repetition. In this case, the UE must have STxMP capability, and the STxMP mode (e.g., SDM method/mode or SFN method/mode) may be enabled in advance through higher layer signaling (e.g., RRC signaling). For this purpose, the existing SRS resource set indication field may be redefined and used, or a new DCI field may be introduced.

Two methods are being considered for the Rel-18 STxMP transmission technique: single frequency network (SFN) and spatial division multiplexing (SDM).

The SFN method is a method in which the same channel (or RS) transmitted from one panel is transmitted from another panel. However, since the UL channel (or RS) of each panel is different, it is transmitted using a different precoder, different transmission power, and different transmission beam (i.e., spatial relation RS indicated by UL TCI) for each panel.

The SDM method is a method that can be transmitted from rank 2 or higher, in which some of the multi-layers are transmitted on panel 1 and the remaining layers are transmitted on panel 2. For example, in a 2-layer transmission, the first layer can be transmitted on panel 1 and the second layer can be transmitted on panel 2. Even in this case, since the UL channels of each panel are different, different precoders, different transmission powers, and different transmission beams (i.e., spatial relation RSs indicated by UL TCI) are used for transmission for each panel.

The following operations may be supported for dynamic switching between STxMP SDM mode and sTRP transmission.
For sTRP transmission, the maximum number of layers of sTRP transmission may be configured by maxRank (or Lmax).
For SDM mode: A single maximum number of layers (e.g., separate from maxRank (or Lmax) in case of sTRP) may be configured, which applies separately to the first SRS resource set and the second SRS resource set.

The total number of PUSCH antenna ports used for SDM and sTRP may be the same, but is not limited thereto.

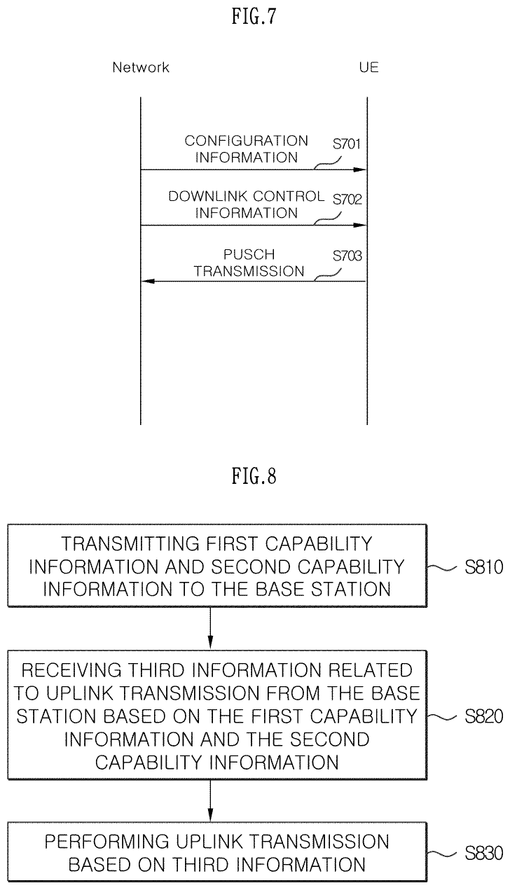

FIG. 7 illustrates a signaling procedure between a network and a UE for a PUSCH transmission and reception method according to one embodiment of the present disclosure.

FIG. 7 illustrates signaling between a network (e.g., TRP 1, TRP 2) and a UE in a situation of multiple TRPs (i.e., M-TRP, or multi-cell, hereinafter, all TRPs can be replaced with cells) to which the methods proposed in the present disclosure (e.g., combinations of one or more of the proposed methods in Embodiments 1 to 4-1, described below) can be applied.

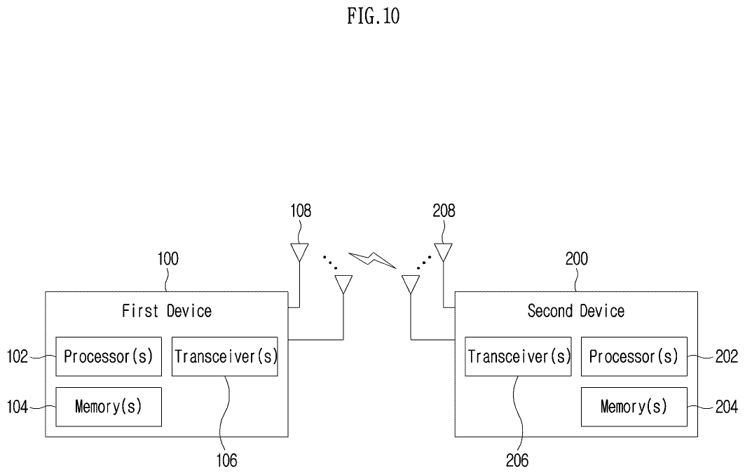

Here, the UE/network side is exemplary and may be replaced with various devices as described with reference to FIG. 10. FIG. 7 is provided for convenience of explanation and does not limit the scope of the present disclosure. In addition, some step(s) shown in FIG. 7 may be omitted depending on the situation and/or settings. In addition, in the operation of the network side/UE of FIG. 7, the above-described uplink transmission/reception operation, M-TRP-related operation, etc. may be referenced or utilized.

In the following description, the network side may be a single base station including multiple TRPs, or may be a single cell including multiple TRPs. Alternatively, the network side may include multiple RRHs (remote radio heads)/RRUs (remote radio units). For example, an ideal/non-ideal backhaul may be established between TRP 1 and TRP 2 constituting the network side. In addition, although the following description is based on multiple TRPs, it can be equally extended and applied to transmission through multiple panels/cells, and can also be extended and applied to transmission through multiple RRHs/RRUs, etc.

A panel may be replaced with an expression such as an SRS resource set, a CORESET group (or a CORESET pool), a TRP, a beam, a capability value index, an antenna array, a cell (e.g., a macro cell/small cell/pico cell, etc.), a transmission point (TP), a base station (gNB, etc.), etc. As described above, a panel and/or a TRP may be distinguished based on information about a CORESET group (or a CORESET pool) (e.g., a CORESET index, an ID).

For example, if a single terminal is configured to transmit and receive with multiple TRPs (or cells), this may mean that multiple CORESET groups (or CORESET pools) are configured for the single terminal. The configuration of such CORESET groups (or CORESET pools) may be performed through higher layer signaling (e.g., RRC signaling, etc.).

In addition, the base station may be a general term for an object that performs data transmission and reception with a terminal. For example, the base station may be a concept that includes one or more TPs (Transmission Points), one or more TRPs (Transmission and Reception Points), etc. In addition, the TPs and/or TRPs may include a panel of the base station, a transmission and reception unit, etc.

Meanwhile, although not shown in FIG. 7, for example, the UE may report UE capability information to the network via/using TRP 1 (and/or TRP 2).

Here, in case of a UE supporting multi-panel (i.e., STxMP) uplink (e.g., PUSCH) transmission, the UE capability information may include at least one of i) information on a codebook subset supported for each of the first panel and the second panel, and ii) information on a codebook subset supported for each of multi-panel transmission (i.e., STxMP) and non-multi-panel transmission (i.e., STRP (single TRP) transmission). Additionally, the UE capability information reported by the UE to the base station may include various types of capability information described in Embodiments 1 to 4-1 below.

The UE may receive configuration information from the network via/using TRP 1 (and/or TRP 2) (S701).

The above configuration information may include information related to network configuration (e.g., TRP configuration)/information related to M-TRP-based transmission and reception (e.g., resource allocation, etc.). In this case, the configuration information may be transmitted through higher layer signaling (e.g., RRC signaling, MAC-CE, etc.).

In addition, for example, the configuration information may include information for configuring joint TCI and/or separate DL/UL TCI. For example, the configuration information may include a list of TCI states that provide a reference for determining an uplink transmission spatial filter of a DMRS/uplink signal (e.g., SRS) of an uplink channel (e.g., PUSCH, PUCCH).

In addition, for example, the configuration information may include information on a multi-panel (i.e., STxMP) PUSCH transmission scheme. For example, it may include information (e.g., a higher layer parameter multipanelscheme) that sets whether to transmit multi-panel (i.e., STxMP), and through the information, whether to transmit STxMP and the STxMP transmission scheme (e.g., SDM scheme or SFN scheme) may be configured.

In addition, for example, the configuration information may include information for configuring the maximum number of layers per panel for multi-panel (i.e., STxMP) PUSCH transmission. That is, when the UE supports two panels and multi-panel PUSCH transmission is configured through two panels, the configuration information may include first information/parameter for configuring the maximum number of layers for the first panel (e.g., upper layer parameter maxRank1, higher layer parameter for configuring Lmax1 value, etc.) and second information/parameter for configuring the maximum number of layers for the second panel (e.g., higher layer parameter maxRank2, higher layer parameter for configuring Lmax2 value, etc.). In addition, the configuration information may further include third information/parameter for configuring the maximum number of layers for STRP PUSCH transmission (e.g., higher layer parameter maxRank, higher layer parameter for configuring Lmax value, etc.). Additionally, the configuration information may further include codebook subset information for the first panel (e.g., higher layer parameter codebookSubset1) and codebook subset information for the second panel (e.g., higher layer parameter codebookSubset2).

In addition, for example, the configuration information may include information on an SRS resource set, and at least two SRS resource sets may be configured for the multi-panel PUSCH transmission. Here, as the usage for the SRS resource set is configured as ‘codebook’ or ‘non-codebook’, it may be indicated whether the PUSCH transmission scheduled by the DCI referencing the corresponding SRS resource set corresponds to a codebook-based uplink transmission or a non-codebook-based uplink transmission.

In addition, the above configuration information may include configuration information related to STRP PUSCH transmission or multi-panel (i.e., STxMP) PUSCH transmission described in the proposed method described below (e.g., a combination of one or more of the proposed methods in Embodiments 1 to 4-1).

The UE may receive downlink control information (DCI) from the network through/using TRP 1 (and/or TRP 2) (S702).

The DCI may be transmitted via a downlink control channel (e.g., PDCCH) and may schedule a STRP PUSCH transmission or a multi-panel (STxMP) PUSCH transmission (i.e., including a UL grant).

Additionally, the DCI may include a sounding reference signal (SRS) resource set indicator field, a first precoding-related field, and a second precoding-related field.

Here, based on the value of the SRS resource set indicator field, it may be indicated whether the PUSCH transmission scheduled by the DCI is a STRP PUSCH transmission (e.g., the value of the SRS resource set indicator field is 00 or 01) or a multi-panel (STxMP) PUSCH transmission (e.g., the value of the SRS resource set indicator field is 10 or 11).

In addition, when the PUSCH transmission is a codebook-based transmission, the first precoding-related field and the second precoding-related field may correspond to a first precoding information and number of layers field and a second precoding information and number of layers field, respectively.

In addition, when the PUSCH transmission is a non-codebook-based transmission, the first precoding-related field and the second precoding-related field may correspond to a first sounding reference signal (SRS) resource indicator field and a second SRS resource indicator field, respectively.

A precoder and/or rank applied across one or more layers for a first panel may be indicated/determined by the first precoding-related field, and a precoder and/or rank applied across one or more layers for a second panel may be indicated/determined by the second precoding-related field.

The UE may transmit a PUSCH to the network through/using TRP 1 (and/or TRP 2) (S703).

Here, in case of STRP PUSCH transmission, the UE may perform STRP PUSCH transmission to the network through/using a single TRP according to the scheduling of DCI based on a single spatial relationship RS (or UL TCI state).

Alternatively, in case of multi-panel (STxMP) PUSCH transmission, the UE may perform multi-panel (STxMP) PUSCH transmission (SDM mode or SFN mode) to the network through/using multiple TRPs using multiple panels according to scheduling of DCI based on different spatial relationship RSs (or different UL TCI states).

### UE Capability Reporting and Beam Reporting Operation

A UE in a basic wireless communication system (e.g., a UE in Release 17) can report to a base station the maximum number of SRS ports that the UE's transmission panel may support as a capability value. Here, if the UE has multiple transmission panels and the maximum number of SRS ports supported by each of the multiple transmission panels is different, the UE may report to the base station the maximum number of SRS ports supported by each transmission panel through the UE capability information.

For example, assume that a UE has three transmitting panels (e.g., panel 1, panel 2, and panel 3). For example, if the maximum number of SRS ports that can be supported for each transmitting panel is 2, 2, and 4, the UE may report {2, 4} as a capability value to the base station. For another example, if the maximum number of SRS ports that can be supported for each transmitting panel is 2, 2, and 2, the UE may report {2} as a capability value to the base station. For another example, if the maximum number of SRS ports that can be supported for each transmitting panel is 1, 2, and 4, the UE may report {1, 2, 4} as a capability value to the base station.

After reporting the capability value related to the maximum number of SRS ports that can be supported per transmitting panel, the UE may measure beam measurement (BM) RS (e.g., SSB, CSI-RS, etc.) and report CRI/SSBRI (SSB resource indicator) and L1-RSRP/L1-SINR to the base station. That is, while performing the above-described beam reporting operation, the UE may also report the index of the capability value to the base station.

For example, if a panel that receives a beam measurement RS may be used as a transmitting panel, the UE may identify the maximum number of SRS ports supported by the panel within the capability value, and may report the identified capability value together when performing a beam reporting operation.

For example, assume that the capability value is {2, 4} and two beam measurement RSs (e.g., BM RS 1 and BM RS 2) are configured. In this case, the value corresponding to capability index 1 is 2, and the value corresponding to capability index 2 is 4. The UE may report the capability value index (i.e., 1) for BM RS 1. Therefore, when the receiving panel of BM RS 1 is used as a transmitting panel, the maximum number of SRS ports that the panel can support can be reported as 2. Additionally, the UE may report the capability value index (i.e., 2) for BM RS 2. Therefore, when the receiving panel of BM RS 2 is used as a transmitting panel, the maximum number of SRS ports that the panel can support can be reported as 4.

The base station that receives the beam report may set UL beam information (i.e., UL TCI state) for UL transmission to the UE. If the UL beam information is set to BM RS 1 (e.g., via UL TCI state), the maximum rank of the corresponding UL transmission or/and the maximum number of ports of the corresponding SRS resource may be set or expected to be 2 or less. And, if the UL beam information is set to BM RS 2 (e.g., via UL TCI state), the maximum rank of the corresponding UL transmission or/and the maximum number of ports of the corresponding SRS resource may be set or expected to be 4 or less.

As described above, the UE has multiple transmitting panels, and the maximum number of SRS ports supported by each of the multiple transmitting panels may differ. The UE may perform UE capability information and beam reporting by considering the properties of each panel.

Hereinafter, a method for reporting UE capabilities and beam reporting is described when multiple transmitting panels have different properties (e.g., maximum number of SRS ports, antenna coherency, full power mode).

FIG. 8 is a diagram for describing an uplink transmission operation of a UE in a wireless communication system to which the present disclosure can be applied.

FIG. 8 illustrates the operation of a UE based on methods according to the present disclosure (e.g., a combination of one or more of the proposed methods in Embodiments 1 to 4-1, Embodiments 1 to 4-1). The examples in FIG. 8 are provided for convenience of explanation and do not limit the scope of the present disclosure. Some of the step(s) illustrated in FIG. 8 may be omitted depending on the circumstances and/or settings.

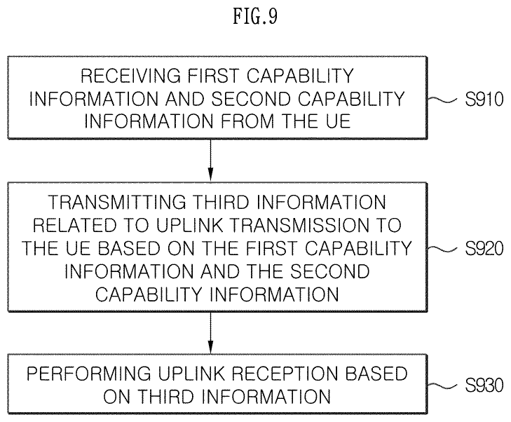

In FIGS. 8 and 9, the capability value index may be replaced with or correspond to/mapped to a panel (or panel identifier (ID), an SRS resource set (or an SRS resource set index), a CORESET group/pool (or a CORESET group/pool index), a TRP (or a TRP index), a beam (or a beam index), an antenna array (or an antenna array index), a cell (or a cell index), etc.

For example, the first capability value index can be replaced/corresponded to the first panel (or the ID of the first panel), and the second capability value index can be replaced/corresponded to/mapped to the second panel (or the ID of the second panel).

As another example, the first panel may be mapped to SRS resource set 0 and the second panel may be mapped to SRS resource set 1. The SRS resources of SRS resource set 0 may refer to the transmit antenna ports of the first panel, and the SRS resources of SRS resource set 1 may refer to the transmit antenna ports of the second panel.

The UE may transmit first capability information related to a plurality of capability value indices and second capability information related to coherency between the plurality of capability values to the base station (S810). However, this is only one embodiment, and the UE may transmit only one of the first capability information and the second capability information to the base station.

For example, the first capability information may include ii) a maximum number of sounding reference signal (SRS) ports supported by each of the plurality of capability value indices, and ii) at least one of a coherence type or a power mode supported by each of the plurality of capability value indices.

Here, the coherence type supported by each of the plurality of capability value indices may be one of full coherence, partial coherence, or non-coherence. In addition, the power mode supported by each of the plurality of capability value indices may be full power mode 1 or full power mode 2. In addition, the full power mode 2 may include full power mode 2 based on antenna virtualization or full power mode 2 based on transmit precoding matrix indicator (TPMI). That is, the full power mode 2 may be classified into full power mode 2 based on antenna virtualization or full power mode 2 based on TPMI.

For example, if there is no power mode supported by the first capability value index (or the first panel), the power mode related information for the first capability value index may be set to “none” or the like.

As an example of the present disclosure, the first capability information may be configured by combining at least one of the maximum number of SRS ports supported by each of a plurality of capability value indices, coherence type, or power mode.

For example, the first capability information corresponding to the first capability value index may be composed of (a, b, c). Here, a represents the maximum number of SRS ports supported by the first capability value index, b represents a coherence type supported by the first capability value index, and c represents a power mode supported by the first capability value index. However, this is only an example, and the positions of a, b, and c may be changed, and at least one of a, b, and c may be omitted.

The type of coherence combination between a plurality of capability indices may be indicated through the second capability information. For example, the type of coherence combination between the first capability value index and the second capability value index may be indicated as a full coherence combination or a partial coherence combination through the second capability information.

As an example of the present disclosure, the first capability information and the second capability information may be reported to the base station during a beam reporting procedure. For example, based on a beam measurement reference signal (RS) based on a first capability value index among a plurality of capability value indices being received from the base station, the UE may transmit the first capability information and the second capability information related to the first capability value index to the base station together with a beam measurement result based on the beam measurement reference signal.

The UE may receive third information related to uplink transmission from the base station based on the first capability information and the second capability information (S820).

For example, the third information may include (uplink) transmission configuration indicator (TCI) status information or spatial relation information for uplink transmission. The UE may set beam information corresponding to multiple capability value indices through (uplink) TCI state information or spatial relation information.

Here, the third information may be transmitted from the UE to the base station through RRC signaling, MAC (medium access control) CE (control element), or DCI (downlink control information).

The UE may perform uplink transmission based on third information (S830). For example, if the third information includes configuration information for uplink transmission transmitted via RRC signaling, the UE may receive DCI for scheduling uplink transmission. The UE may perform uplink transmission scheduled by the DCI.

Here, the uplink transmission may include, but is not limited to, physical uplink shared channel (PUSCH) transmission.

As an example of the present disclosure, based on the coherence (full coherence) combination between a first capability value index and a second capability value index among a plurality of capability value indices being indicated through the second capability information, the UE may receive third information related to uplink transmission using at least one SRS port associated with the first capability value index and/or at least one SRS port associated with the second capability value index. Accordingly, the UE may perform uplink transmission using at least one SRS port associated with the first capability value index and at least one SRS port associated with the second capability value index.

For example, it is assumed that the coherence combination is indicated as the full coherence combination through the second capability information, and a coherency type and the maximum number of SRS ports supported by the first capability value index are the full coherence and N (N is a natural number greater than or equal to 1), and a coherency type and the maximum number of SRS ports supported by the second capability value index are the full coherence and M (M is a natural number greater than or equal to 1).

Here, the UE may receive third information related to uplink transmission (i.e., STxMP) using the full coherent codebook of N+M ports and/or the first capability value index and the second capability value index simultaneously from the base station. Accordingly, the UE may perform uplink transmission using the first capability value index and the second capability value index simultaneously based on the full coherent codebook of N+M ports.

As another example of the present disclosure, it is assumed that the coherence combination is indicated as a non-coherence combination through the second capability information, and a coherency type and the maximum number of SRS ports supported by the first capability value index are the total coherence and N (N is a natural number greater than or equal to 1), and a coherency type and the maximum number of SRS ports supported by the second capability value index are the total coherence and M (M is a natural number greater than or equal to 1).

Here, the UE may receive from the base station third information related to uplink transmission using the N+M port full coherent codebook in which two SRS port groups are set and/or the first capability value index and the second capability value index simultaneously. Accordingly, the UE may perform uplink transmission using the first capability value index and the second capability value index simultaneously based on the N+M port partial coherent codebook in which two SRS port groups (i.e., “Ng=2”) are configured. Here, each of the two port groups can include N coherent SRS ports and M coherent SRS ports.

The method described in the example of FIG. 8 can be performed by the first device (100) of FIG. 10. That is, the base station of FIG. 10 can be implemented by the first device (100). For example, one or more processors (102) of the first device (100) of FIG. 10 can transmit first capability information related to a plurality of capability value indices and second capability information related to coherency between the plurality of capability values to the base station through one or more transceivers (106). The one or more processors (102) can receive third information related to uplink transmission from the base station through one or more transceivers (106) based on the first capability information and the second capability information. The one or more processors (102) can perform uplink transmission through one or more transceivers (106) based on the third information.

Furthermore, one or more memories (104) of the first device (100) may store commands for performing the method described in the example of FIG. 8 or the examples described below when executed by one or more processors (102).

FIG. 9 is a diagram for describing an uplink reception operation of a base station in a wireless communication system to which the present disclosure can be applied.

The base station may receive first capability information related to a plurality of capability value indices and second capability information related to coherency between the plurality of capability values from the UE (S910).

For example, the base station may transmit a beam measurement reference signal based on a first capability value index among a plurality of capability value indices to the UE. The base station may receive first capability information and/or second capability information related to the first capability value index from the UE together with a beam measurement result based on the beam measurement reference signal.

Since the configuration examples of the first capability information and the second capability information have been described with reference to FIG. 8, redundant descriptions will be omitted.

The base station may transmit third information related to uplink transmission to the UE based on the first capability information and the second capability information (S920).

That is, the base station may generate third information for uplink transmission by considering the maximum number of SRS ports, coherence type, or/and power mode supported by each of a plurality of capability value indices, and transmit the generated third information to the UE.

The base station may perform uplink reception based on third information (S930)

The method described in the example of FIG. 9 can be performed by the second device (200) of FIG. 10. That is, the base station of FIG. 9 can be implemented by the second device (200). For example, one or more processors (202) of the second device (200) of FIG. 10 can receive first capability information related to a plurality of capability value indices and second capability information related to coherency between the plurality of capability values from a UE through one or more transceivers (206). The one or more processors (202) can receive third information related to uplink transmission to the UE through one or more transceivers (206) based on the first capability information and the second capability information. The one or more processors (202) can perform uplink reception based on the third information.

Furthermore, one or more memories (204) of the second device (200) may store commands for performing the method described in the example of FIG. 10 or the examples described below when executed by one or more processors (202).

Hereinafter, the operations of the UE and base station of FIGS. 8 and 9 will be described in detail. That is, the UE and base station of FIGS. 8 and 9 may perform all or part of the operations according to the embodiments described below (e.g., embodiments 1 to 4-1). That is, embodiments 1 to 4-1 may be applied independently, but one or more operations/parameters according to each of embodiments 1 to 4-1 can also be applied in combination with each other.

### Embodiment 1

Embodiment 1 relates to a capability/beam reporting method of a UE when coherency-related capabilities are different for each of multiple panels.

As an example of the present disclosure, it is assumed that a UE has three transmitting panels (e.g., panel 1, panel 2, and panel 3). Panel 1 may have a capability to precisely control the phase difference between transmitting ports (i.e., full coherency capability). Panel 2 may have a capability to precisely control the phase difference between one or more ports within port group 1 and one or more ports within port group 2, but not to control the phase difference between the two port groups (i.e., partial coherency capability). Panel 3 may not have a capability to precisely control the phase difference between any of its transmitting ports. That is, panel 3 may be in a non-coherency state and may have a non-coherency capability.

As described above, when the coherency capability is different for each panel, a capability value 2 for reporting the coherency-related capability for each panel can be newly defined. The UE may report {full coherence, partial coherence, non-coherence} to the base station as the capability value 2. That is, the capability value 2 may indicate that panel 1 has a full coherence capability, panel 2 has a partial coherence capability, and panel 3 has a non-coherence capability.

Additionally or alternatively, the UE may report capability value 1 (i.e., capability related to the maximum number of SRS ports supported per panel) to the base station together with capability value 2 (i.e., capability related to coherency supported per panel).

For example, assume that the maximum number of SRS ports supported by panel 1, panel 2, and panel 3 are 2, 2, and 4, respectively. Here, the UE may report capability value 2 to the base station by pairing the maximum number of SRS ports supported by each panel with the coherence capability. At this time, capability value 2 may be {(2, full-coherence), (2, partial coherence), (4, non-coherence)}. Here, capability value 2 can be configured in the order of panel index. That is, (2, full-coherence) is for panel 1, (2, partial coherence) is for panel 2, and (4, non-coherence) is for panel 3.

A UE reporting full coherence capability may also have partial/non-coherence capabilities in addition to full coherence capabilities. Having the capability to match full antenna coherence may mean that transmission can be performed only by matching coherence between ports of a subset of antennas or without matching coherence between ports. Similarly, a UE reporting partial coherence capability may also have non-coherence capabilities.

### Embodiment 2

Embodiment 2 relates to a capability/beam reporting method of a UE when power mode-related capabilities differ for each panel. When the full power mode support capabilities differ for each panel, a capability value of 3 for reporting power mode-related capabilities for each panel may be newly defined.

As an example of the present disclosure, it is assumed that a UE has three transmitting panels (e.g., panel 1, panel 2, and panel 3). In this case, panel 1 (e.g., a low-cost panel, etc.) does not support full power mode (e.g., full power transmission is possible only when all antennas within the panel are used due to low output of the PA per antenna), panel 2 can support full power mode 1, and panel 3 can support full power mode 2.

The UE may report capability value 3 corresponding to panel 1, panel 2, and panel 3 to the base station. Here, capability value 3 can be {none, full power mode 1, full power mode 2}. That is, through capability value 3, panel 1 does not support full power mode, panel 2 supports full power mode 1, and panel 3 can support full power mode 2.

Additionally or alternatively, the full power mode support capability per panel may be reported to the base station along with the capability related to the maximum number of SRS ports supported per panel (i.e., the capability value in the underlying wireless communication system).

For example, assume that the maximum number of SRS ports supported by panel 1, panel 2, and panel 3 are 2, 2, and 4, respectively. In this case, the maximum number of SRS ports supported by each panel and the power mode supported by each panel can be paired and reported to the base station as capability 3. In this case, capability 3 can be {(2, none), (2, full power mode 1), (4, full power mode 2)}.

Here, the capability value 3 may be configured in the order of the panel indexes. That is, (2, none) is for panel 1, (2, full power mode 1) is for panel 2, and (4, full power mode 2) is for panel 3.

### Embodiment 2-1

Embodiment 2-1 relates to a capability reporting method when the entire power mode 2 is subdivided.

As an example of the present disclosure, in the case of full power mode 2, full power may be supported through antenna virtualization, or full power may be supported through a specific TPMI (transmit precoding matrix indicator) group type that enables full power transmission. The UE may report to the base station through capability information whether full power mode based on antenna virtualization or a specific TPMI group type is supported for each panel.

As an example of the present disclosure, a UE may report capability information (“ul-FullPwrMode2-SRSConfig-diffNumSRSPorts”) to a base station indicating that it supports full power mode 2 based on antenna virtualization. The capability information indicating that it supports full power mode 2 based on antenna virtualization may indicate that a UE with a different number of antenna ports per SRS resource supports SRS configuration for uplink full power mode 2 operation. The number of different antenna ports that may be configured for an SRS resource may be as follows.
The value p1-2 means that each SRS resource can be set to 1 port or 2 ports.
Values p1-4 indicate that each SRS resource can be configured with 1 port or 4 ports.
Values p1-2-4 indicate that each SRS resource can be configured with 1 port, 2 ports, or 4 ports.

The UE shall indicate the above specific support and may also indicate support of “ul-FullPwrMode2-MaxSRS-ResInSet”. “ul-FullPwrMode2-MaxSRS-ResInSet” may indicate the UE's support for the maximum number of SRS resources in one SRS resource set with the usage set to ‘codebook’ for uplink full power mode 2 operation.

A UE may report capability information (“ul-FullPwrMode2-TPMIGroup”) to a base station indicating that it supports a full power mode based on a specific TPMI group type. The capability information indicating that it supports a full power mode based on a specific TPMI group type may indicate a UE-supported TPMI group that provides full power. The capability information indicating that it supports a full power mode based on a specific TPMI group type may be configured with the following values.
“twoPorts-r16” may indicate a 2-bit bitmap.
“fourPortsNonCoherent-r16” may indicate TPMI group {G0-3}.
“fourPortsPartialCoherent-r16” may indicate TPMI group (G0-6).

The UE may indicate support of the above features, and may also indicate support of “ul-FullPwrMode2-MaxSRS-ResInSet”.

When a fully coherent UE operates in (full power) mode 2, it may report TPMI in the same manner as a partial-coherent UE. For a 4-port partial coherent or full coherent UE, the UE may report one of the 2-port {2-bit bitmap} and the 4-port non-coherent {G0~G3} and one of the 4-port partial coherent {G0~G6}. For a 4-port non-coherent UE, the UE may report one of the 2-port {2-bit bitmap} and the 4-port non-coherent {G0~G3}. For a 2-port UE, the UE may report the 2-port {2-bit bitmap}. A UE supporting the above features may report one of the values described above.

### Embodiment 3

In one embodiment of the present disclosure, it is assumed that a panel that receives an RS/beam selected by CRI/SSBRI in beam reporting is used as an uplink transmission panel. In this case, the UE may report the antenna coherence capability and the full power mode support capability of the corresponding panel together to the base station.

For example, assume that the first CSI-RS among four CSI-RSs is selected as the CRI and the panel used when receiving the CSI-RS is used as the uplink transmission panel. The UE may report the antenna coherence capability of the corresponding panel to the base station together with an index of capability value 2. Here, if the corresponding panel is panel 1, the UE may report CRI=0 (corresponding to the first CSI-RS) and an index of capability value 2 (i.e., 1) to the base station. As another example, if the corresponding panel is panel 2, the UE may report CRI=0 (corresponding to the first CSI-RS) and an index of capability value 2 (i.e., 2) to the base station.

For example, assume that the first CSI-RS among four CSI-RSs is selected as the CRI and the panel used when receiving the CSI-RS is used as the uplink transmission panel. The UE may report the capability related to full power mode support of the corresponding panel to the base station along with an index of capability value 3. Here, if the corresponding panel is panel 1, the UE may report CRI=0 (corresponding to the first CSI-RS) and an index of capability value 3 (i.e., 1) to the base station. As another example, if the corresponding panel is panel 2, the UE may report CRI=0 (corresponding to the first CSI-RS) and an index of capability value 3 (i.e., 2) to the base station.

### Embodiment 3-1

In Embodiments 1, 2, 2-1, and 3, it was described that the capability related to antenna coherence and the capability related to the full power mode are each reported as separate capability values. However, this is only one embodiment, and the capability related to antenna coherence and the capability related to the full power mode may be integrated into the same capability value and reported to the base station.

As an example of the present disclosure, capabilities related to the number of maximum SRS ports per panel (e.g., panel 1, panel 2, and panel 3), capabilities related to antenna coherence, and capabilities related to full power mode can be paired into one capability value and reported to the base station.

Here, the capability values reported to the base station may be {(2, full-coherence, none), (2, partial-coherence, full power mode 1), (4, non-coherence, full power mode 2)}. Here, the capability values may be configured in the order of the panel indexes. For example, {(2, full-coherence, none) is for panel 1, (2, partial-coherence, full power mode 1) is for panel 2, and (4, non-coherence, full power mode 2) is for panel 3.

That is, the UE may report that panel 1 has the capability of (2, full-coherence, none), panel 2 has the capability of (2, partial-coherence, full power mode 1), and panel 3 has the capability of (4, non-coherence, full power mode 2).

When performing beam reporting, the UE may report the index of the capability value (or panel index, etc.) together with the CRI/SSBRI.

For example, assume that the first CSI-RS among four CSI-RSs is selected as the CRI and the panel used when receiving the corresponding CSI-RS is used as the uplink transmission panel. In this case, if the corresponding panel is panel 1, the UE may report the index of the capability value corresponding to panel 1 (i.e., 1) to the base station together with the CRI. As described above, if multiple types of capabilities of each panel are paired and defined as one capability value, the capability value can be redefined as a set of capability values.

### Embodiment 3-2

The operations of the above-described embodiment can be applied to a non-group based beam reporting procedure, but can also be applied to a group based beam reporting procedure.

For example, assume that among four CSI-RSs, the first CSI-RS and the second CSI-RS are selected as a CRI pair, and the panel used when each CSI-RS is received is used as an uplink transmission panel. In this case, the UE may report the full power mode support capability of the corresponding panels as an index with a capability value of 3 (together with CRI/SSBRI).

If the panels that received the first CSI-RS and the second CSI-RS are panel 1 and panel 2, respectively, the UE may report the index of the capability value 2 corresponding to panel 1 (e.g., 1) and the index of the capability value 2 corresponding to panel 2 (e.g., 2) together with “CRI=0 and 1 (corresponding to the first/second CSI-RS).”

### Embodiment 4

Embodiment 4 relates to a method for reporting coherent STxMP capabilities. Specifically, a UE may report to a base station a capability indicating whether antenna port coherence is supported between transmitting panels.

As an example of the present disclosure, it is assumed that a UE has panel 1, panel 2, and panel 3, and that the UE may control the phase difference between the antenna port(s) of panel 1 and the antenna port(s) of panel 2. In addition, it is assumed that the UE has full coherency capability for the panel 1 and panel 2 pairs, but does not have full coherency capability for the remaining panel combinations.

Here, the UE may report the full coherent panel combination together with the capability values to the base station. For example, if the capability values for panel 1, panel 2, and panel 3 (e.g., {(2, full-coherence, none), (2, partial-coherence, full power mode 1), (4, non-coherence, full power mode 2)}) are reported to the base station, the UE may additionally report information related to panel 1 and panel 2, which are the full coherent panel combinations, to the base station. As an example, the UE may report UE capability information for the coherent panel combination to the base station, and the UE capability information can be configured as (capability value index=1, capability value index=2). That is, (capability value index=1, capability value index=2) can indicate that panel 1 corresponding to capability value index 1 and panel 2 corresponding to capability value index 1 are a full coherent panel combination.

Accordingly, the base station may identify a combination of panels capable of coherent transmission (i.e., panels corresponding to beams capable of coherent transmission) through the beam report received from the UE. For example, when the capability value indices reported by the beam reporting procedure are 1 and 2, the base station can identify that the two panels corresponding to the capability value indices 1 and 2, respectively, are capable of coherent transmission. As another example, when the capability value indices reported by the beam reporting procedure are 2 and 3, the base station can identify that the two panels corresponding to the capability value indices 2 and 3, respectively, are incapable of coherent transmission.

### Embodiment 4-1

The capability information described in Embodiment 4 (i.e., capability information related to coherent panel combination) can be used when a base station schedules PUSCH transmission based on multiple transmission panels of a UE.

For example, assume that panels 1 and 2 are coherent panel combinations, and the capability value for panel 1 is (4, full-coherence) and the capability value for panel 2 is (4, full-coherence). That is, coherent transmission between panels 1 and 2 is possible, the maximum number of SRS ports supported by each of panel 1 and panel 2 is 4, and each of panel 1 and panel 2 can have full coherent capabilities. In this case, the UE may perform PUSCH transmission using both panels simultaneously based on an 8-port full coherent codebook.

As another example, assume that panel 2 and panel 3 are non-coherent panel combinations, and the capability value for panel 2 is (4, full-coherence) and the capability value for panel 3 is (4, full-coherence). In this case, the UE may perform PUSCH transmission using both panels simultaneously based on an 8-port partial coherent codebook with the Ng value set to 2. Here, Ng may mean the number of coherent port groups among 8 ports. An 8-port partially coherent codebook with Ng set to 2 may mean a codebook that is coherent between 4 ports (e.g., group 1) among 8 ports, coherent between the remaining 4 ports (e.g., group 2), and non-coherent between two groups.

As another example, assume that panel 2 and panel 3 are non-coherent panel combinations, and the capability value for panel 2 is (4, partial-coherence) and the capability value for panel 3 is (4, partial-coherence). In this case, the UE may perform PUSCH transmission using both panels simultaneously based on an 8-port partial coherent codebook with the Ng value set to 4.

Here, an 8-port partially coherent codebook with Ng set to 4 means a codebook in which 8 ports are grouped into 2-port units, and the ports belonging to each group are coherent with each other, but are designed such that the ports are not coherent between the groups.

Additionally or alternatively, a method of informing the base station of whether coherence is supported between transmitting panels reported to the base station through the UE's beam reporting procedure may be applied.

For example, the UE may select CSI-RS 1 and 2 as CRIs through group-based beam reporting, and report capability value indices (e.g., 1 and 2) corresponding to CSI-RS 1 and 2 to the base station. Additionally, the UE may additionally report to the base station whether the transmitting panels that received the selected CSI-RS 1 and 2 are coherent with each other when used as transmitting panels.

The above-described embodiments can be ultimately applied/performed through combination or combination, etc. Additionally, whether or not to apply the operations according to the above-described embodiments and/or the parameters can be set/instructed from the base station to the UE, and can also be set/defined as a fixed value.

General Device to which the Present Disclosure May be Applied

FIG. 10 illustrates a block diagram of a wireless communication device according to an embodiment of the present disclosure.

In reference to FIG. 10, a first wireless device 100 and a second wireless device 200 may transmit and receive a wireless signal through a variety of radio access technologies (e.g., LTE, NR).

A first wireless device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts disclosed in the present disclosure.

For example, the processor 102 may process the information in the memory 104 to generate first information/signal and then transmit a wireless signal including the first information/signal through the transceiver 106. Additionally, the processor 102 may receive a wireless signal including the second information/signal through the transceiver 106 and then store information obtained from signal processing of the second information/signal in the memory 104.

A memory 104 may be connected to a processor 102 and may store a variety of information related to an operation of a processor 102. For example, a memory 104 may store a software code including commands for performing all or part of processes controlled by a processor 102 or for performing description, functions, procedures, proposals, methods and/or operation flow charts disclosed in the present disclosure. Here, a processor 102 and a memory 104 may be part of a communication modem/circuit/chip designed to implement a wireless communication technology (e.g., LTE, NR). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a wireless device may mean a communication modem/circuit/chip.

A second wireless device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts disclosed in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including commands for performing all or part of processes controlled by a processor 202 or for performing description, functions, procedures, proposals, methods and/or operation flow charts disclosed in the present disclosure. Here, a processor 202 and a memory 204 may be part of a communication modem/circuit/chip designed to implement a wireless communication technology (e.g., LTE, NR). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a wireless device may mean a communication modem/circuit/chip.

Hereinafter, a hardware element of a wireless device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC, RLC, PDCP, RRC, SDAP). One or more processors 102, 202 may generate one or more PDUs (Protocol Data Unit) and/or one or more SDUs (Service Data Unit) according to description, functions, procedures, proposals, methods and/or operation flow charts included in the present disclosure. One or more processors 102, 202 may generate a message, control information, data or information according to description, functions, procedures, proposals, methods and/or operation flow charts disclosed in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206. One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts disclosed in the present disclosure.

One or more processors 102, 202 may be referred to as a controller, a micro controller, a micro processor or a micro computer. One or more processors 102, 202 may be implemented by a hardware, a firmware, a software, or their combination. In an example, one or more ASICs (Application Specific Integrated Circuit), one or more DSPs (Digital Signal Processor), one or more DSPDs (Digital Signal Processing Device), one or more PLDs (Programmable Logic Device) or one or more FPGAs (Field Programmable Gate Arrays) may be included in one or more processors 102, 202. Description, functions, procedures, proposals, methods and/or operation flow charts disclosed in the present disclosure may be implemented by using a firmware or a software and a firmware or a software may be implemented to include a module, a procedure, a function, etc. A firmware or a software configured to perform description, functions, procedures, proposals, methods and/or operation flow charts disclosed in the present disclosure may be included in one or more processors 102, 202 or may be stored in one or more memories 104, 204 and driven by one or more processors 102, 202. Description, functions, procedures, proposals, methods and/or operation flow charts disclosed in the present disclosure may be implemented by using a firmware or a software in a form of a code, a command and/or a set of commands.

One or more memories 104, 204 may be connected to one or more processors 102, 202 and may store data, a signal, a message, information, a program, a code, an instruction and/or a command in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. disclosed in the present disclosure from one or more other devices. For example, one or more transceivers 106, 206 may be connected to one or more processors 102, 202 and may transmit and receive a wireless signal. For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. disclosed in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefore, one or more transceivers 106, 206 may include an (analogue) oscillator and/or a filter.

Embodiments described above are that elements and features of the present disclosure are combined in a predetermined form. Each element or feature should be considered to be optional unless otherwise explicitly mentioned. Each element or feature may be implemented in a form that it is not combined with other element or feature. In addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure.

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

Here, a wireless communication technology implemented in a wireless device 100, 200 of the present disclosure may include Narrowband Internet of Things for a low-power communication as well as LTE, NR and 6G. Here, for example, an NB-IoT technology may be an example of a LPWAN (Low Power Wide Area Network) technology, may be implemented in a standard of LTE Cat NB1 and/or LTE Cat NB2, etc. and is not limited to the above-described name. Additionally or alternatively, a wireless communication technology implemented in a wireless device 100, 200 of the present disclosure may perform a communication based on a LTE-M technology. Here, in an example, a LTE-M technology may be an example of a LPWAN technology and may be referred to a variety of names such as an eMTC (enhanced Machine Type Communication), etc. For example, an LTE-M technology may be implemented in at least any one of various standards including 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M and so on and it is not limited to the above-described name. Additionally or alternatively, a wireless communication technology implemented in a wireless device 100, 200 of the present disclosure may include at least any one of a ZigBee, a Bluetooth and a low power wide area network (LPWAN) considering a low-power communication and it is not limited to the above-described name. In an example, a ZigBee technology may generate PAN (personal area networks) related to a small/low-power digital communication based on a variety of standards such as IEEE 802.15.4, etc. and may be referred to as a variety of names.

A method proposed by the present disclosure is mainly described based on an example applied to 3GPP LTE/LTE-A, 5G system, but may be applied to various wireless communication systems other than the 3GPP LTE/LTE-A, 5G system.

1. A method comprising:
transmitting, by a user equipment (UE) to a base station, first capability information related to a plurality of capability value indices and second capability information related to coherency between the plurality of capability values;
receiving, by the UE from the base station, third information related to the uplink transmission based on the first capability information and the second capability information; and
performing uplink transmission based on the third information,
wherein the first capability information includes i) a maximum number of sounding reference signal (SRS) ports supported by each of the plurality of capability value indices and ii) at least one of a coherence type or a power mode supported by each of the plurality of capability value indices.

2. The method of claim 1, wherein:
the coherence type supported by each of the plurality of capability value indices is one of full coherence, partial coherence, or non-coherence.

3. The method of claim 1, wherein:
a power mode supported by each of the plurality of capability value indices is full power mode 1 or full power mode 2, and
the full power mode 2 includes full power mode 2 based on antenna virtualization or full power mode 2 based on transmit precoding matrix indicator (TPMI).

4. The method of claim 1, wherein:
based on a beam measurement reference signal (RS) based on a first capability value index among the plurality of capability value indices being received from the base station, the first capability information and the second capability information related to the first capability value index are transmitted from the UE to the base station together with a beam measurement result based on the beam measurement reference signal.

5. The method of claim 1, wherein:
based on a coherence combination between a first capability value index and a second capability value index among the plurality of capability value indices being indicated through the second capability information, the uplink transmission is performed using at least one SRS port associated with the first capability value index and at least one SRS port associated with the second capability value index.

6. The method of claim 5, wherein:
based on the coherence combination being indicated as a full coherence combination through the second capability information, a coherency type and a maximum number of SRS ports supported by the first capability value index being a full coherence and N (where N is a natural number greater than or equal to 1), and a coherency type and a maximum number of SRS ports supported by the second capability value index being a full coherence and M (where M is a natural number greater than or equal to 1): based on an N+M port full coherent codebook, the uplink transmission is performed using the first capability value index and the second capability value index simultaneously.

7. The method of claim 5, wherein:
based on the coherence combination being indicated as a non-coherence combination through the second capability information, a coherency type and a maximum number of SRS ports supported by the first capability value index being each equal to the full coherence and N (where N is a natural number greater than or equal to 1), and a coherency type and a maximum number of SRS ports supported by the second capability value index being each equal to a full coherence and M (where M is a natural number greater than or equal to 1), based on an N+M port partial coherent codebook in which two SRS port groups are configured, the uplink transmission is performed using the first capability value index and the second capability value index simultaneously.

8. The method of claim 7, wherein:
each of the two port groups includes N coherent SRS ports and M coherent SRS ports.

9. The method of claim 1, wherein:
the third information includes transmission configuration indicator (TCI) state information or spatial relation information for the uplink transmission.

10. The method of claim 1, wherein:
the third information is received from the base station through RRC signaling, medium access control (MAC) control element (CE) or downlink control information (DCI).

11. A user equipment (UE) comprising:
at least one transceiver; and
at least one processor coupled to the at least one transceiver;
wherein the at least one processor is configured to:
transmit, to a base station through the at least one transceiver, first capability information related to a plurality of capability value indices and second capability information related to coherency between the plurality of capability values;
receive, from the base station through the at least one transceiver, third information related to the uplink transmission based on the first capability information and the second capability information; and
perform uplink transmission based on the third information,
wherein the first capability information includes i) a maximum number of sounding reference signal (SRS) ports supported by each of the plurality of capability value indices and ii) at least one of a coherence type or a power mode supported by each of the plurality of capability value indices.

12. (canceled)

13. A base station comprising:
at least one transceiver; and
at least one processor coupled to the at least one transceiver;
wherein the at least one processor is configured to:
receive, from a user equipment (UE) through the at least one transceiver, first capability information related to a plurality of capability value indices and second capability information related to coherency between the plurality of capability values;
transmit, to the UE through the at least one transceiver, third information related to the uplink transmission based on the first capability information and the second capability information; and
perform uplink reception based on the third information,
wherein the first capability information includes i) a maximum number of sounding reference signal (SRS) ports supported by each of the plurality of capability value indices and ii) at least one of a coherence type or a power mode supported by each of the plurality of capability value indices.
